(19) United States
(12) Patent Application Publication
(10) Pub. No.: US 2026/0338182 A1
(43) Pub. Date: Oct. 29, 2026

(54) LANTERN RING ASSEMBLY FOR A RECIPROCATING PUMP

(71) Applicant: GD Energy Products, LLC, Tulsa, OK (US)

(72) Inventor: James Robert Yanus, Tulsa, OK (US)

(21) Appl. No.: 19/657,373

(22) Filed: Apr. 24, 2026

Related U.S. Application Data
(60) Provisional application No. 63/794,939, filed on Apr. 25, 2025.

(51) Int. Cl. F04B 53/16; F16J 15/18

(52) U.S. Cl. CPC F04B 53/164; F16J 15/183

(57) ABSTRACT

A lantern ring assembly of a packing assembly configured to seal against a reciprocating pump includes an upstream surface configured to engage an adjacent ring of the packing assembly. The upstream surface includes tapered surfaces that are oriented at an angle greater than 90 degrees with respect to one another.

### CROSS-REFERENCE TO RELATED APPLICATION

This application claims priority to and the benefit of U.S. Provisional Patent Application No. 63/794,939, entitled “LANTERN RING ASSEMBLY FOR A RECIPROCATING PUMP,” filed Apr. 25, 2025, which is hereby incorporated by reference for all purposes.

### TECHNICAL FIELD

The present disclosure relates to the field of high pressure reciprocating pumps and, in particular, to a lantern ring assembly of a packing assembly of the reciprocating pump, or at least to a portions of the lantern ring assembly.

### BACKGROUND

High pressure reciprocating pumps are often used to deliver high pressure fluids during earth drilling operations. During operation of a reciprocating pump, a reciprocating element moves to pressurize fluid. During this reciprocating movement, a packing assembly seals against the reciprocating element to reduce the likelihood of leakage of fluid between a pump casing and the reciprocating element. The packing assembly includes multiple rings that are coupled to one another in a manner that allows the packing assembly to seal against the reciprocating element. The rings are subject to stress and wear during operation of the reciprocating pump.

### SUMMARY

The present application relates to a lantern ring assembly for a reciprocating pump or to a packing assembly.

In accordance with one embodiment, a lantern ring assembly of a packing assembly for a reciprocating pump is provided. The lantern ring assembly includes a hole configured to receive lubricant and direct lubricant toward a reciprocating element of the reciprocating pump and a surface configured to receive a portion of an adjacent ring of the packing assembly. The surface includes tapered surfaces extending toward one another, and the tapered surfaces are oriented at an obtuse angle relative to one another.

In accordance with another embodiment, a lantern adapter ring of a packing assembly for a reciprocating pump. The lantern adapter ring includes a first surface configured to engage a lantern lubricant ring of the packing assembly and a second surface, opposite the first surface, configured to engage an adjacent ring of the packing assembly. The second surface includes tapered portions extending toward one another, and the tapered portions are oriented at an obtuse angle relative to one another.

In accordance with yet another embodiment, a packing assembly for a reciprocating pump is provided. The packing assembly includes a pressure ring configured to seal against a reciprocating element of the reciprocating pump and a lantern ring configured to receive a portion of the pressure ring. The lantern ring includes an upstream surface configured to engage the portion of the pressure ring, and the upstream includes tapered surfaces oriented with one another at greater than 90 degrees.

### BRIEF DESCRIPTION OF THE DRAWINGS

To complete the description and in order to provide for a better understanding of the present application, a set of drawings is provided. The drawings form an integral part of the description and illustrate embodiments of the present application, which should not be interpreted as restricting the scope of the disclosure, but just as examples. The drawings comprise the following figures:

FIG. 1 is a front perspective view of a reciprocating pump including a fluid end and a power end, in accordance with embodiments of the present disclosure.

FIG. 2 is a side cross-sectional view of a reciprocating pump.

FIG. 3 is a side perspective view of a packing assembly configured to be implemented in a reciprocating pump, in accordance with embodiments of the present disclosure.

FIG. 4 is a side cross-sectional view of the packing assembly of FIG. 3, in accordance with embodiments of the present disclosure.

FIG. 5 is another side cross-sectional view of another packing assembly, in accordance with embodiments of the present disclosure.

FIGS. 6-11 are each side cross-sectional views of various lantern ring assemblies of a packing assembly, or portions thereof, in accordance with embodiments of the present disclosure.

Like reference numerals have been used to identify like elements throughout this disclosure.

### DETAILED DESCRIPTION

The following description is not to be taken in a limiting sense but is given solely for the purpose of describing the broad principles of the disclosure. Embodiments of the disclosure will be described by way of example, with reference to the above-mentioned drawings showing elements and results according to the present disclosure.

Generally, the present application is directed to a lantern ring assembly (e.g., a lantern ring, a spacer ring, an adapter ring) of a packing assembly for a reciprocating pump that includes at least one reciprocating element (e.g., a plunger) that reciprocates to pressurize fluid. Specifically, during operation of the reciprocating pump, the packing assembly, including the lantern ring assembly, is provided around a reciprocating element of the reciprocating pump. The reciprocating element moves within or adjacent a casing of a fluid end of the reciprocating pump. For example, an intake stroke of the reciprocating element may reduce a pressure within a pumping chamber of the fluid end of the reciprocating pump to draw fluid into the pumping chamber. Meanwhile, a discharge stroke of the reciprocating element may increase the pressure within the pumping chamber to pressurize the fluid and discharge the pressurized fluid from the pumping chamber. During operation of the reciprocating pump, the reciprocating element alternates between the intake stroke and the discharge stroke to repeatedly pressurize fluid. The packing assembly blocks fluid flow between the reciprocating element and the casing.

To this end, the packing assembly is positioned to sealingly engage with the reciprocating element via different rings, each having a specific shape to perform a desirable (e.g., different) function. These different rings are engaged with one another to ensure they can sealingly engage the reciprocating element. For example, a lantern ring assembly supports the positioning of other rings and abuts an adjacent ring, such as a pressure ring, to provide the packing assembly. Specifically, the lantern ring assembly includes a recess or cup configured to receive the adjacent ring. Operation of the reciprocating pump imparts forces onto the packing assembly, which may cause stress to concentrate around the recess of the lantern ring assembly. However, the lantern ring assembly disclosed herein has a particular recess geometry to limit such stress concentrations to reduce wear and therefore improve a useful lifespan of the lantern ring assembly. In particular, the recess is flatter (i.e., has a smoother or softer transition) to reduce a sharpness of the recess profile that otherwise may increase stress concentrations. For example, the recess includes tapered surfaces/portions that intersect with one another and/or at an arcuate surface/portion. The tapered surfaces are oriented at an angle that is greater than 90 degrees (e.g., 95 degrees, 100 degrees, 110 degrees) with one another to limit stress concentrations.

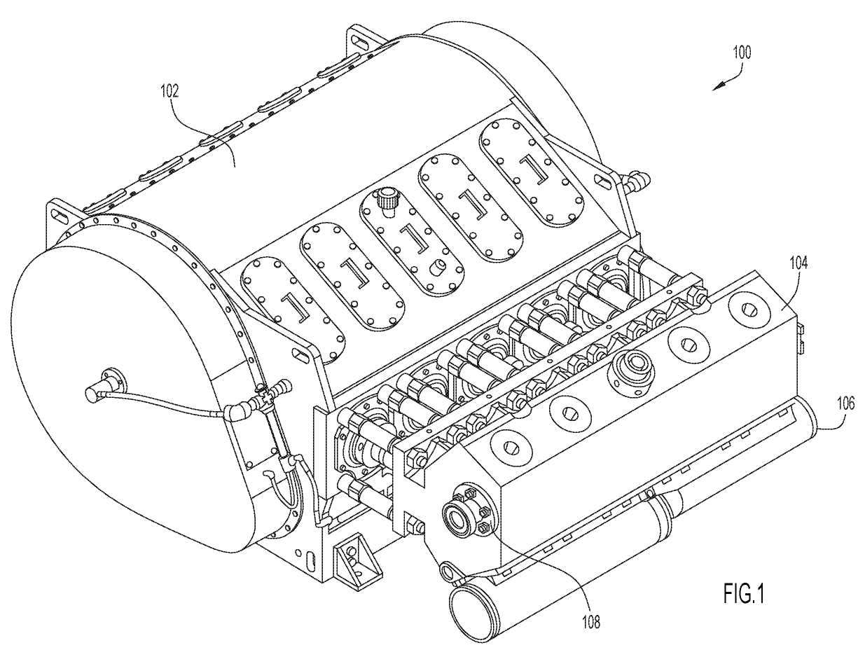

Turning now to the drawings, FIG. 1 illustrates a reciprocating pump 100. The reciprocating pump 100 includes a power end 102 and a fluid end 104. The power end 102 includes a crankshaft that drives a plurality of reciprocating plungers or pistons (generally referred to as “reciprocating elements”) enclosed within the fluid end 104 to receive fluid via a piping system 106 and pump fluid at high pressure via a channel 108 (e.g., to cause the fluid end 104 to deliver high pressure fluids to earth drilling operations). For example, the power end 102 may be configured to support hydraulic fracturing (i.e., fracking) operations, where fracking liquid (e.g., a mixture of water, chemicals, and/or sand) is injected into rock formations at high pressures to allow natural oil and gas to be extracted from the rock formations. However, to be clear, this example is not intended to be limiting, and the present application may be applicable to both fracking and drilling operations, as well as any other suitable operations.

In any case, often, the reciprocating pump 100 may be quite large and may, for example, be supported by a semi-tractor truck (“semi”) that can move the reciprocating pump 100 to and from a well. Specifically, in some instances, a semi may move the reciprocating pump 100 off a well to perform maintenance on the reciprocating pump 100. However, a reciprocating pump 100 is typically moved off a well only when a replacement pump (and an associated semi) is available to move into place at the well, which may be rare. Thus, often, the reciprocating pump 100 is taken offline at a well, and maintenance is performed while the reciprocating pump 100 remains on the well. If not for this maintenance, the reciprocating pump 100 could operate continuously to extract natural oil and gas (or conduct any other operation). Consequently, any improvements that extend the lifespan of components of the reciprocating pump 100, extend the time between maintenance operations (i.e., between downtime), and/or minimize the time to complete maintenance operations (minimizing downtime) are highly desirable.

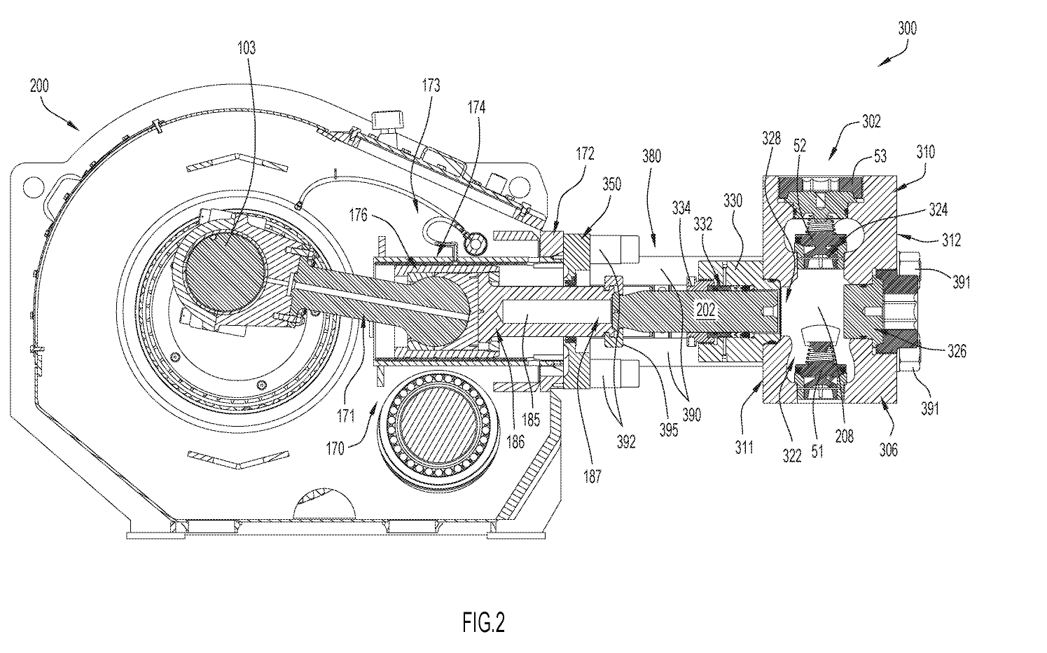

FIG. 2 shows a side, cross-sectional view of a reciprocating pump 300, which may be representative of the reciprocating pump 100, and includes a power end 200 and a fluid end 302 coupled to one another. In particular, a mount plate 350 is attached to a nose plate 172 of the power end 200 via a first set of couplers 392, and a second set of couplers 390 extends through the mount plate 350 and through the fluid end 302 from a front side 311 to a back side 312 of a casing 306 of the fluid end 302 to couple the mount plate 350 to the fluid end 302. Nuts 391 are installed on the second set of couplers 390 at the back side 312 to secure the fluid end 302 to the second set of couplers 390 and therefore to the power end 200. This also establishes a cradle 380 between the power end 200 and the fluid end 302.

Operation of the power end 200 drives a reciprocating element 202 to move relative to the fluid end 302. To this end, the power end 200 includes a crankshaft 103, as well as a crosshead assembly 170 that converts rotational motion of the crankshaft 103 into linear, reciprocating motion of the reciprocating element 202. The crosshead assembly 170 includes a connecting rod 171, a crosshead 173, and a pony rod 185. The crosshead 173 includes a connector 176 disposed within a crosshead frame 174 and coupled to a back side 186 the pony rod 185, and the connecting rod 171 extends from the crankshaft 103 to the connector 176. The connector 176 is configured to move linearly within the crosshead frame 174, and opposite ends of the connecting rod 171 are configured to travel with the crankshaft 103 and the connector 176. Thus, rotation of the crankshaft 103 drives the connector 176 to linearly reciprocate within the crosshead frame 174, which drives corresponding reciprocating movement of the pony rod 185. A front side 187 of the pony rod 185 is coupled to the reciprocating element 202 via a clamp 395 such that reciprocating movement of the pony rod 185 also drives reciprocating movement of the reciprocating element 202 relative to the fluid end 302.

Such movement of the reciprocating element 202 pressurizes fluid in a pumping chamber 208 of the fluid end 302. FIG. 2 depicts a single pumping chamber 208. However, it should be understood that a fluid end 104 can include multiple pumping chambers 208 arranged side-by-side. In fact, in at least some embodiments (e.g., the embodiment of FIG. 1), the casing 306 of the fluid end 104 forms a plurality of pumping chambers 208, and each pumping chamber 208 includes a reciprocating element 202 that reciprocates within the casing 306 via operation of the crankshaft 103. However, side-by-side pumping chambers 208 need not be defined by a single casing 306. For example, in some embodiments, the fluid end 302 may be modular, and different casing segments may house one or more pumping chambers 208. In any case, the one or more pumping chambers 208 are arranged side-by-side so that corresponding conduits are positioned adjacent to each other and generate substantially parallel pumping action. Specifically, with each stroke of the reciprocating element 202, low pressure fluid is drawn into the pumping chamber 208 and high pressure fluid is discharged from the pumping chamber 208.

In the depicted embodiment, the fluid end 302 includes a first bore 328 that intersects an inlet bore 322 and an outlet bore 324. The inlet bore 322 defines a fluid path through the fluid end 302 that connects the pumping chamber 208 to a piping system (e.g., the piping system 106) delivering fluid to the fluid end 302. Meanwhile, the outlet bore 324 allows compressed fluid to exit the fluid end 302. Thus, in operation, the bores 322 and 324 may include valve components 51 and 52, respectively, (e.g., one-way valves) that allow the bores 322 and 324 to selectively open and deliver a fluid through the fluid end 302. Typically, the valve components 51 in the inlet bore 322 may be secured therein by the piping system. Meanwhile, the valve components 52 in the outlet bore 324 may be secured therein by a closure assembly 53 that, in the example illustrated in FIG. 2, is removably coupled to the fluid end 302 via threads. The fluid end 302 also has an access bore 326 formed into the back side 312 of the casing 306 to help provide access to the above mentioned parts and/or the pumping chamber 208, such as for performing maintenance operations. Each of the bores 322, 324, 326, 328 extends from an exterior surface 310 of the casing 306 to the pumping chamber 208.

In operation, fluid may enter the fluid end 302 via outer openings of the inlet bores 322 and exit the fluid end 104 via outer openings of the outlet bores 324. More specifically, fluid may enter the inlet bores 322 via pipes of the piping system, flow through the pumping chamber 208 (due to reciprocation of a reciprocating element 202), and then through the outlet bores 324 into a channel (e.g., the channel 108). However, the piping system and the channel are merely example conduits and, in various embodiments, the fluid end 302 may receive and discharge fluid via any number of pipes and/or conduits, along pathways of any desirable size or shape.

Meanwhile, each of the first bores 328 defines, at least in part, a cylinder for the reciprocating elements 202 and/or connects the casing 306 to a cylinder for the reciprocating elements 202. Reciprocation of the reciprocating element 202 in or adjacent to the first bore 328, which may be referred to as a reciprocation bore (or, for fracking applications, a plunger bore), draws fluid into the pumping chamber 208 via the inlet bore 322 and pumps the fluid out of the pumping chamber 208 via the outlet bore 324.

Additionally, the casing 306 is configured to receive a removable stuffing box 330 at the first bore 328. The removable stuffing box 330 can be coupled to the casing 306 with couplers (e.g., bolts), threads, and/or any other retaining techniques, and the removable stuffing box 330 may support a packing arrangement or assembly 332 with packing seals. The packing assembly 332 is configured to seal against the reciprocating element 202 disposed interiorly of the packing assembly 332. The packing assembly 332 therefore blocks fluid from flowing between the casing 306 and the reciprocating element 202 (e.g., to force fluid flow to the outlet bore 324). Moreover, the packing assembly 332 can block abrasive material (e.g., debris) within the fluid from wearing against the casing 306 and/or against the reciprocating element 202. Thus, the packing assembly 332 may help maintain a desirable structural integrity of the casing 306 and/or of the reciprocating element 202 to improve a useful lifespan of the reciprocating pump 300.

The packing assembly 332 includes multiple rings that are coupled to one another and installed within the removable stuffing box 330 to seal against the reciprocating element 202. Thus, removing the removable stuffing box 330 from the fluid end casing 306 removes the packing seal assembly 332 from the casing 306, e.g., for replacement or repair. In the depicted embodiment, the packing assembly 332 includes or engages a packing nut 334 that threads into the removable stuffing box 330 to retain the packing assembly 332 in the removable stuffing box 330. However, the packing assembly 332 may be retained in the removable stuffing box 330 in any suitable manner in additional or alternative embodiments.

One of the rings of the packing assembly 332 includes a lantern ring assembly having a recess configured to receive an adjacent ring. The recess includes tapered surfaces/portions that intersect with one another and/or with an arcuate surface/portion. The tapered surfaces are oriented at an angle greater than 90 degrees with one another to reduce stress concentrations, thereby reducing wear and increasing a useful lifespan of the lantern ring assembly. In some embodiments, the lantern ring assembly functions as the packing nut 334 to retain the packing assembly 332 within the removable stuffing box 330.

In various embodiments, the fluid end 302 may be shaped differently and/or have different features, but may still generally perform the same functions, define similar structures, and house similar components. For example, while the first bore 328 of the depicted fluid end 104 may intersect the inlet bore 322 and the outlet bore 324 at any desired angle or angles, for example, to intersect the first bore 328 (and/or an access bore) substantially orthogonally and/or so that two or more bores 322, 324, 326, 328 are substantially coaxial or skewed. Generally, the bores 322 and 324, as well as any other bores (i.e., segments, conduits, etc.), may intersect to form a pumping chamber 208, may be cylindrical or non-cylindrical, and/or may define openings at the external surface 310 of the casing 306. Additionally, the bores 322 and 324, as well as any other bores (i.e., segments, conduits, etc.), may receive various components or structures, such as sealing assemblies or components thereof.

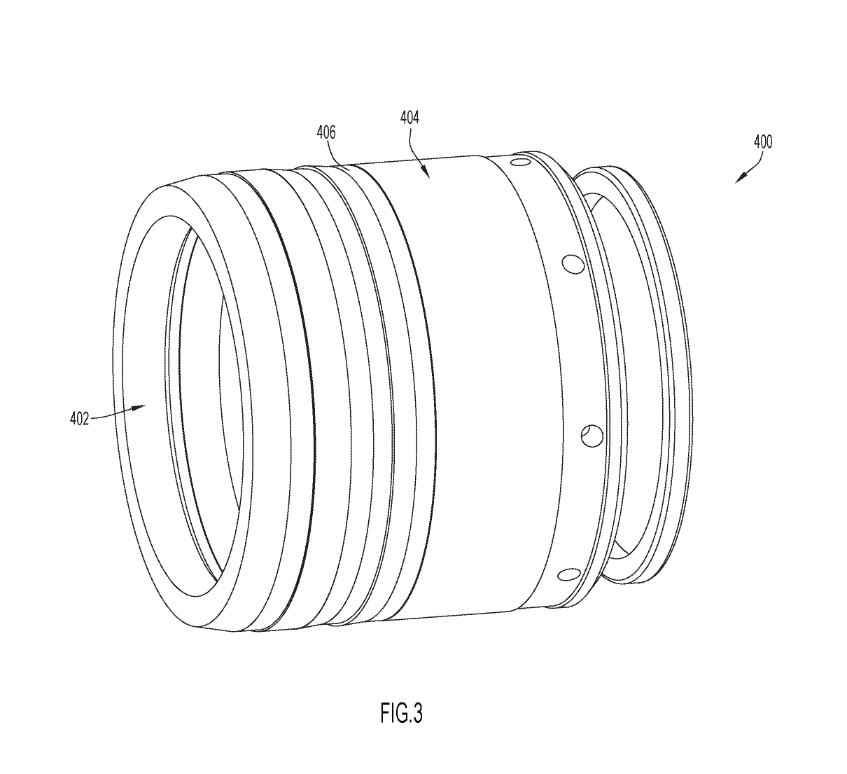

FIG. 3 is a perspective view of a packing assembly 400 configured to be implemented in a reciprocating pump, such as the fluid end 104 of the reciprocating pump 100. The packing assembly 400 includes multiple rings that are configured to couple to one another and that cooperatively define an opening 402 configured to receive a reciprocating element (e.g., the reciprocating element 202), insofar as the term “couple” and variations thereof may be used herein to denote engagement or abutment and do not necessarily require mating or interlocking. At least a subset of the rings is configured to sealingly engage the reciprocating element to block fluid flow along a portion of the reciprocating element.

The packing assembly includes a lantern ring assembly 404 coupled to an adjacent ring 406, such as a pressure ring, to support other rings of the packing assembly 400. In some embodiments, the lantern ring assembly 404 includes separate rings configured to couple to one another to cooperatively form the lantern ring assembly 404. In alternative embodiments, the lantern ring assembly 404 includes a single, integral piece.

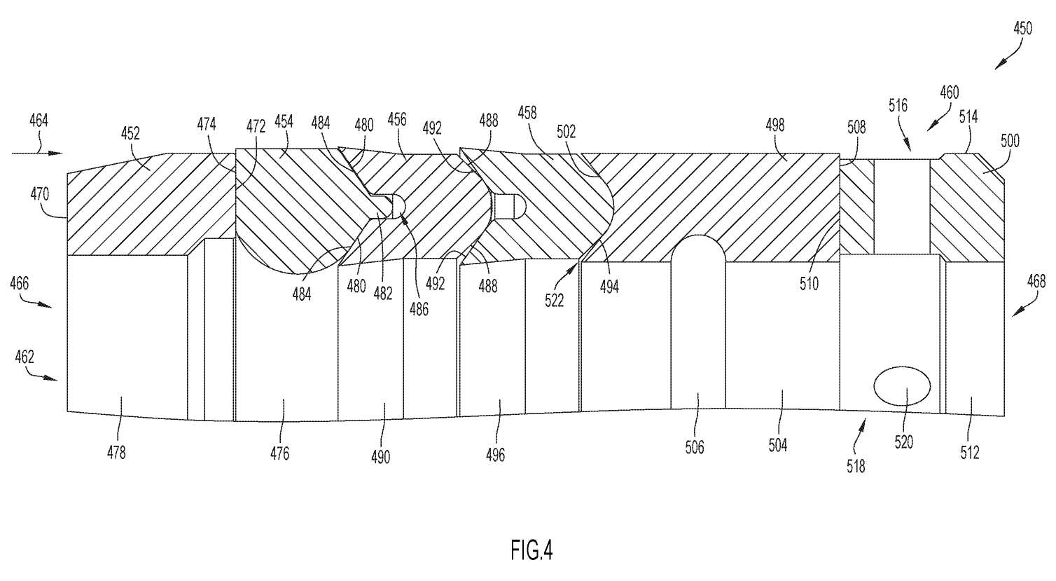

FIG. 4 is a side cross-sectional view of a packing assembly 450. The packing assembly 450 includes a junk ring 452, a header ring 454, a first pressure ring 456, a second pressure ring 458, and a lantern ring assembly 460. In additional or alternative embodiments, the packing assembly 450 includes any other suitable types and/or quantities of rings, such as only a single pressure ring. Each ring 452, 454, 456, 458, 460 extends annularly to cooperatively define an opening 462 configured to receive a reciprocating element. Additionally, the rings 452, 454, 456, 458, 460 are positioned sequentially (e.g., side-by-side) along an axis 464. The rings 452, 454, 456, 458, 460 are arranged to prevent or at least discourage fluid leakage between a fluid end and the reciprocating element.

Before discussing the arrangement of the packing assembly 450 in detail, it is important to understand the terms “upstream” and “downstream.” Specifically, any flow through the packing assembly 450 or between the packing assembly 450 and the reciprocating element flows from a high pressure side 466 of the packing assembly 450 toward a low pressure side 468 of the packing assembly. Thus, if a first component is described as being “upstream” of a second component, the first component will be closer to the high pressure side 466 than the second component is positioned relative to the high pressure side 466. Likewise, if a first component is described as being “downstream” of a second component, the first component will be closer to the low pressure side 468 than the second component is positioned relative to the low pressure side 468. In the depicted packing assembly 450, the header ring 454 is positioned downstream of the junk ring 452, the pressure rings 456, 458 are positioned downstream of the header ring 454, and the lantern ring assembly 460 is positioned downstream of the pressure rings 456, 458 adjacent to the low pressure side 468. However, the rings 452, 454, 456, 458, 460 of the packing assembly 450 may be arranged in any suitable manner in other embodiments.

In some embodiments, the casing of the fluid end includes a cavity in which the packing assembly 450 is configured to be inserted to implement the packing assembly 450 in the fluid end. In alternative embodiments, the fluid end includes a stuffing box inserted into and coupled to the casing, and the packing assembly 450 may be inserted into a cavity of the stuffing box. In either case, the packing assembly 450 may be threadless and retained within the fluid end via an interference fit instead of via a threaded engagement to ease installing and uninstalling the packing assembly 450 with respect to the fluid end.

Regardless of the manner in which the packing assembly 450 is arranged in the fluid end, implementing the packing assembly 450 in the fluid end positions the junk ring 452 adjacent to the high pressure side 466. Thus, the junk ring 452 includes a front surface 470 configured to abut (e.g., sealingly engage) part of the fluid end, such as a casing or a stuffing box inserted into and coupled to the casing. The junk ring 452 may receive a significant amount of force generated during operation of the fluid end, and the junk ring 452 serves as a barrier that limits an amount of force transferred to the other rings 454, 456, 458, 460, thereby helping maintain a structural integrity of the other rings 454, 456, 458, 460. Consequently, the junk ring 452 may be considered a sacrificial component that is relatively more susceptible to wear over time as the fluid end operates. In certain embodiments, the junk ring 452 may be relatively harder to resist deformation and reduce force transfer to other parts of the reciprocating element. For example, the junk ring 452 may be composed of a relatively less resilient or stiffer (e.g., harder) material, such as a metal (e.g., steel, aluminum, bronze, brass), a metal alloy, polymer, and/or a plastic.

The junk ring 452 includes a back surface 472, which is configured to abut (e.g., be positioned approximately flush against) a header ring upstream surface 474 of the header ring 454. The header ring 454 includes a header ring inner surface 476 extending from the header ring upstream surface 474 in the downstream direction. The header ring inner surface 476 is arcuate and is configured to abut and scrape against the reciprocating element. To this end, the header ring inner surface 476 extends radially beyond the junk ring 452 (e.g., past a junk ring inner surface 478). The header ring 454 also includes header ring downstream surfaces 480, opposite the header ring upstream surface 474. The header ring downstream surfaces 480 are tapered and extend toward one another in the downstream direction to form a chevron (e.g., a male chevron) configuration. The illustrated header ring downstream surfaces 480 intersect with an extension 482, which extends farther in the downstream direction (e.g., along the axis 464).

The header ring 454 is configured to expand radially toward the reciprocating element in response to axial compression (e.g., compression along the axis 464) to form a tight seal against the reciprocating element, while also preventing or at least discouraging debris from being trapped against the packing assembly 450 and grinding against sealing areas of the packing assembly 450 (e.g., to scrape debris off the reciprocating element once compressed and sealed thereagainst). In fact, in some embodiments, the header ring 454 may be configured to mate with the junk ring 452 in a manner that cams or pushes the header ring 454 into contact with the reciprocating element. Thus, the header ring 454 may be fabricated from a resilient material, such as a homogeneous elastomer, a filled elastomer, a partially fabric reinforced elastomer, and/or a full fabric reinforced elastomers. Suitable resilient elastomeric materials include, but are not limited to, thermoplastic polyurethane (TPU), thermoplastic copolyester (COPE), ethylene propylene diene monomer (EPDM), highly saturated nitrile rubber (HNBR), reinforced versions of the foregoing materials, such as versions reinforced with fibers or laminations of woven material, as well as combinations of any of the foregoing materials. Such materials allow the header ring 454 to expand radially in response to axial compression.

The stiffness of the junk ring 452 helps the header ring 454 expand toward the reciprocating element. For instance, axially compressing the header ring 454 may impart a force against the junk ring 452. However, the junk ring 452 is sufficiently rigid to withstand the imparted force to avoid corresponding radial expansion. Consequently, the junk ring 452 forces the header ring 454 to expand more radially inward toward the reciprocating element, instead of radially outward away from the reciprocating element, thereby increasing effectiveness of the header ring 454 to tightly seal against the reciprocating element.

The first pressure ring 456 includes first pressure ring upstream surfaces 484, which extend toward one another in the downstream direction to form a chevron (e.g., a female chevron) configuration. Each of the first pressure ring upstream surfaces 484 meets at an aperture 486, which provides a relief space that allows the first pressure ring upstream surfaces 484 to flex (e.g., to become more parallel relative to one another) in response to compression of the first pressure ring 456 against the reciprocating element. The aperture 486 is configured to receive the extension 482 of the header ring 454, and the first pressure ring upstream surfaces 484 of the first pressure ring 456 are configured to engage the header ring downstream surfaces 480. Additionally, the first pressure ring 456 includes a first pressure ring downstream surface 488, which is arcuate to form a chevron (e.g., a male chevron) configuration. The first pressure ring 456 also includes a first pressure ring tapered inner surface 490 configured to abut and seal against the reciprocating element.

The second pressure ring 458 includes similar features as that of the first pressure ring 456 in the illustrated embodiment. That is, the second pressure ring 458 includes second pressure ring upstream surfaces 492 extending toward one another in the downstream direction to form a chevron (e.g., a female chevron) configuration and a second pressure ring downstream surface 494 that is arcuate to form a chevron (e.g., a male chevron) configuration. The second pressure ring upstream surfaces 492 are configured to engage the first pressure ring downstream surface 488 to engage the pressure rings 456, 458 with one another. The second pressure ring 458 also includes a second pressure ring tapered inner surface 496 configured to abut and seal against the reciprocating element.

The pressure rings 456, 458 may be primary sealing components of the packing assembly 450, bearing the brunt of the pressure applied by high pressure fluid. Therefore, the pressure rings 456, 458 may be stiff or inflexible and lack springiness to withstand such pressure. For example, in at least some embodiments, the pressure rings 456, 458 may be formed from an elastomer impregnated with aramid fabric. However, two pressure rings are not necessarily needed to serve this purposes. Indeed, some embodiments might have a single pressure ring.

The lantern ring assembly 460 includes a lantern adapter ring 498 and a lantern lubricant ring 500. The lantern ring assembly 460 is configured to support the position of the other rings 452, 454, 456, 458 and is therefore formed from a metal, such as aluminum, bronze, or an aluminum-bronze alloy, to maintain its positioning and structural integrity. The lantern ring assembly 460 may also deliver lubricant to the other rings 452, 454, 456, 458 and/or the reciprocating element.

The lantern adapter ring 498 includes a lantern adapter ring upstream surface 502 that forms a chevron (e.g., a female chevron) configuration. The lantern adapter ring upstream surface 502 is configured to receive the second pressure ring downstream surface 494 of the second pressure ring 458 to engage the second pressure ring 458 with the lantern adapter ring 498. In fact, as further discussed herein, the lantern adapter ring upstream surface 502 includes tapered surfaces/portions that are oriented at an obtuse angle (i.e., an angle greater than 90 degrees, such as between 91 degrees and 179 degrees) with one another. In particular, the tapered surfaces are oriented at a single, substantially constant angle along the lantern adapter ring upstream surface 502 to enable continuous engagement with the second pressure ring 458 and to simplify manufacture of the lantern adapter ring 498, such as to avoid having to form multiple tapered surfaces oriented at different angles with one another.

The lantern adapter ring 498 includes a lantern adapter ring inner surface 504 configured to face the reciprocating element. The lantern adapter ring inner surface 504 includes a groove 506 facing the reciprocating element and configured to carry lubrication and/or help collect debris. Other embodiments, however, may include other geometries and features at the upstream and inner surfaces to interface with an upstream ring and support a seal (or not) if desired. For example, the lantern adapter ring upstream surface 502 need not have a chevron shape and may be recessed to receive the second pressure ring 458 to couple the lantern adapter ring 498 and the second pressure ring 458 to one another.

The lantern adapter ring 498 further includes a lantern adapter ring downstream surface 508. The lantern lubricant ring 500 includes a lantern lubricant ring upstream surface 510 configured to engage the lantern adapter ring downstream surface 508 of the lantern adapter ring 498 to engage the lantern adapter ring 498 and the lantern lubricant ring 500 with one another. In the depicted embodiment, each of the lantern adapter ring downstream surface 508 and the lantern lubricant ring upstream surface 510 may extend planarly and be positioned flush against one another. Other embodiments, however, may include different geometries.

The lantern lubricant ring 500 includes a lantern lubricant inner surface 512 configured to face the reciprocating element, as well as a lantern lubricant external surface 514 opposite the lantern lubricant inner surface 512. A first recess 516 is formed through the lantern lubricant ring 500 at the lantern lubricant ring external surface 514, a second recess 518 is formed around the lantern lubricant ring 500 at the lantern lubricant inner surface 512, and at least one hole 520 extends through the lantern lubricant ring 500 from the first recess 516 to the second recess 518. The first recess 516 is configured to receive lubricant (e.g., directed through the casing or stuffing box) and direct lubricant around the lantern lubricant ring 500 at the lantern lubricant ring external surface 514 and into the hole(s) 520. Each hole 520 is configured to direct lubricant toward the reciprocating element and into the second recess 518. The second recess 518 is configured to direct lubricant around the lantern lubricant ring 500 at the lantern lubricant inner surface 512 to distribute lubricant around the reciprocating element. For example, implementing the packing assembly 450 in the fluid end may align the first recess 516 with a lubricant channel through which lubricant flows. Other embodiments, however, need not include both recesses. In any case, the lantern ring assembly 460 is configured to help the reciprocating element move along the packing assembly 450 (e.g., along the rings 452, 454, 456, 458, 460) via the lubricant.

In some embodiments, it may be easier to manufacture the lantern adapter ring 498 and the lantern lubricant ring 500 separately and to couple the lantern adapter ring 498 and the lantern lubricant ring 500 to one another to provide the lantern ring assembly 460. For instance, the lantern adapter ring 498 may be manufactured (e.g., to provide the lantern adapter ring upstream surface 502 and the groove 506) and the lantern lubricant ring 500 may be manufactured (e.g., to provide the first recess 516, the second recess 518, and the at least one hole 520) concurrently with one another. The overlap in time to manufacture of the lantern adapter ring 498 and the lantern lubricant ring 500 may reduce a downtime associated with forming features of the lantern ring assembly 460 sequentially with one another to reduce an overall amount of time to manufacture the lantern ring assembly 460.

Additionally or alternatively, the first recess 516 and the second recess 518 may be more easily formed into the lantern lubricant ring 500 that is separate from the lantern adapter ring 498. For instance, the lantern adapter ring downstream surface 508 of the lantern adapter ring 498 may extend radially beyond the lantern adapter ring downstream surface 508 such that the lantern adapter ring downstream surface 508 is exposed to and forms a portion of the first recess 516 and the second recess 518. In other words, each of the first recess 516 and the second recess 518 may extend to the lantern adapter ring downstream surface 508. This may enable the recesses 516, 518 to be more easily formed into the lantern lubricant ring surfaces 512, 514 (e.g., by increasing available directions in which a cutting tool can engage the lantern lubricant ring 500 to remove material to form the recesses 516, 518, such as by enabling the cutting tool to approach from the lantern lubricant ring upstream surface 510 and generally along the axis 464), such as in comparison to an embodiment in which a recess is formed such that the recess does not extend to the lantern adapter ring 498 and is fully contained within the lantern lubricant ring 500 (e.g., and is bordered by separate surfaces of the lantern lubricant ring 500).

In some embodiments, the lantern adapter ring 498 and the lantern lubricant ring 500 are securely coupled to one another. By way of example, another component, such as a fastener and/or an adhesive, may be used to attach the lantern adapter ring downstream surface 508 with the lantern lubricant ring upstream surface 510. Additionally or alternatively, the lantern adapter ring 498 and the lantern lubricant ring 500 are coupled by compressing lantern adapter ring 498 and the lantern lubricant ring 500 against one another. For instance, a packing nut (e.g., the packing nut 334) may compress the lantern adapter ring 498 and the lantern lubricant ring 500 to one another. Such a packing nut may be separate from the lantern adapter ring 498 and the lantern lubricant ring 500 in certain embodiments. However, in other embodiments, the lantern lubricant ring 500 may function as the packing nut. In other words, the lantern lubricant ring 500 is configured to direct lubricant to the reciprocating element via the hole 520 and also compress against the lantern adapter ring 498, which may cause the lantern adapter ring 498 to interface with the adjacent second pressure ring 458 and retain the packing assembly 450 in a fluid end.

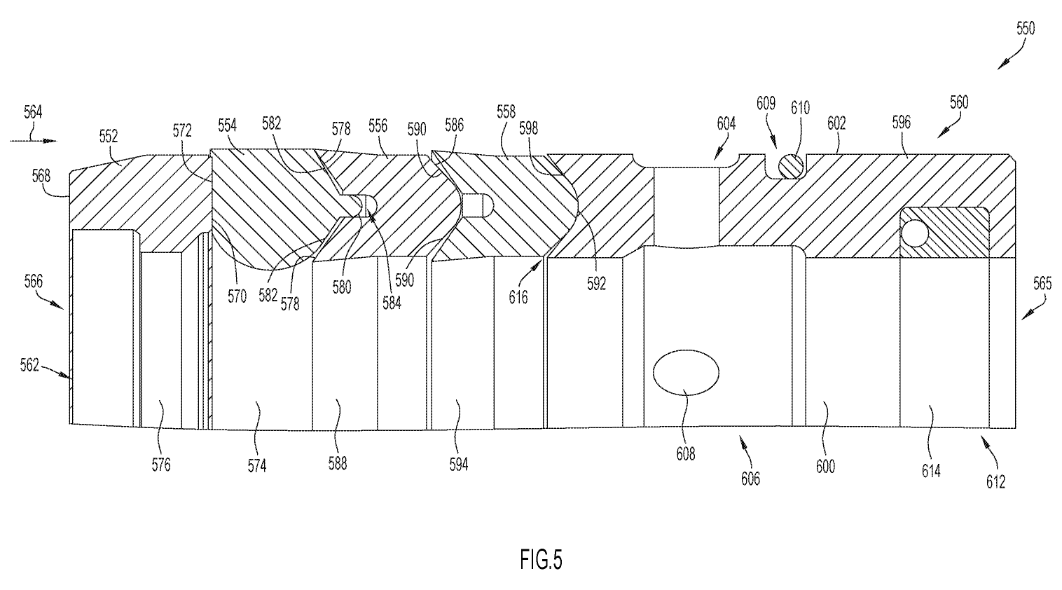

Furthermore, although the lantern ring assembly 460 of the packing assembly 450 includes multiple components (i.e., the lantern adapter ring 498, the lantern lubricant ring 500) coupled to one another, in some embodiments, a lantern ring assembly of a packing assembly includes a single, integral piece. FIG. 5 illustrates such an example. In particular, FIG. 5 is a side cross-sectional view of a packing assembly 550, which includes a junk ring 552, a header ring 554, a first pressure ring 556, a second pressure ring 558, and a lantern ring assembly 560. The packing assembly 550 has similar features to that of the packing assembly 450 and may therefore provide similar benefits herein.

For example, each ring 552, 554, 556, 558, 560 may extend annularly to cooperatively define an opening 562 configured to receive a reciprocating element. Additionally, the rings 552, 554, 556, 558, 560 are positioned sequentially (e.g., side-by-side) along an axis 564. The rings 552, 554, 556, 558, 560 are arranged to prevent or at least discourage fluid leakage between a fluid end and the reciprocating element. In the depicted packing assembly 550, the header ring 554 is positioned downstream of the junk ring 552, the pressure rings 556, 558 are positioned downstream of the header ring 554, and the lantern ring assembly 560 is positioned downstream of the pressure rings 556, 558 adjacent to a low pressure side 565. However, the rings 552, 554, 556, 558, 560 of the packing assembly 550 may be arranged in any suitable manner in other embodiments.

The junk ring 552 is configured to be positioned adjacent a high pressure side 566 such that a front surface 568 abuts (e.g., sealingly engages) part of the fluid end. The junk ring includes a back surface 570 configured to abut (e.g., be positioned approximately flush against) a header ring upstream surface 572 of the header ring 554. The header ring 554 includes a header ring inner surface 574 that extends radially beyond the junk ring 552 (e.g., past a junk ring inner surface 576) to abut and scrape against the reciprocating element. The header ring 554 includes header ring downstream surfaces 578, opposite the header ring upstream surface 572, tapering and extending toward one another in the downstream direction to form a chevron (e.g., a male chevron) configuration. The header ring downstream surface 578 intersect with an extension 580, which extends farther in the downstream direction (e.g., along the axis 564).

The header ring downstream surface 578 is configured to engage first pressure ring upstream surfaces 582 of the first pressure ring 556, which extend toward one another in the downstream direction to form a chevron (e.g., a female chevron) configuration. Each of the first pressure ring upstream surfaces 582 meets at an aperture 584, which is configured to receive the extension 580 of the header ring 554. The first pressure ring 556 also includes a first pressure ring downstream surface 586, which is arcuate to form a chevron (e.g., a male chevron) configuration, as well as a first pressure ring tapered inner surface 588 configured to abut and seal against the reciprocating element.

The second pressure ring 558 includes second pressure ring upstream surfaces 590 extending toward one another in the downstream direction to form a chevron (e.g., a female chevron) configuration and a second pressure ring downstream surface 592 that is arcuate to form a chevron (e.g., a male chevron) configuration. The second pressure ring upstream surfaces 590 are configured to engage the first pressure ring downstream surface 586 to engage the pressure rings 556, 558 with one another. The second pressure ring 558 also includes a second pressure ring tapered inner surface 594 configured to abut and seal against the reciprocating element. To reiterate, however, other embodiments need not include two pressure rings in the packing stack and could include one or more than two.

The lantern ring assembly 560 is configured to be positioned adjacent a low pressure side 565 and includes a lantern ring 596 with a lantern ring upstream surface 598 that forms a chevron (e.g., a female chevron) configuration. The lantern ring upstream surface 598 is configured to receive the second pressure ring downstream surface 592 of the second pressure ring 558 to engage the second pressure ring 558 with the lantern ring 596. The lantern ring includes a lantern ring inner surface 600 configured to face the reciprocating element, as well as a lantern ring outer surface 602, opposite the lantern ring inner surface 600. A first recess 604 is formed around the lantern ring assembly 560 at the lantern ring outer surface 602, a second recess 606 is formed around the lantern ring inner surface 600 at the lantern ring inner surface 600, and at least one hole 608 extends through the lantern ring 596 from the first recess 604 to the second recess 606. The first recess 604 is configured to receive lubricant (e.g., directed through the casing or stuffing box) and direct lubricant around the lantern ring 596 at the lantern ring outer surface 602 and into the hole(s) 608. Each hole 608 is configured to direct lubricant toward the reciprocating element and into the second recess 606. The second recess 606 is configured to direct lubricant around the lantern ring 596 at the lantern ring inner surface 600 to distribute lubricant around the reciprocating element, which helps the reciprocating element move along the packing assembly 550 (e.g., along the rings 552, 554, 556, 558, 560) via the lubricant.

The lantern ring 596 also includes a first groove 609 formed into the lantern ring outer surface 602 and configured to receive a first seal 610 (e.g., a first O-ring, a first lip seal), which is configured to compress against the casing or stuffing box to help retain the lantern ring 596 within the fluid end. The lantern ring 596 further includes a second groove 612 configured to receive a second seal 614 (e.g., a second O-ring, a second lip seal), which is configured to compress against the reciprocating element to provide a seal between the reciprocating element and the lantern ring 596 (e.g., to block lubricant flow toward the high pressure side 566).

The lantern ring upstream surface 598 is recessed to receive the second pressure ring 558 to couple the lantern ring 596 and the second pressure ring 558 to one another. For instance, similar to the lantern adapter ring upstream surface 502, the lantern ring upstream surface 598 may include tapered surfaces/portions that are oriented at an obtuse angle (i.e., an angle greater than 90 degrees, such as between 91 degrees and 179 degrees) with one another. In particular, the tapered surfaces are oriented at a single, substantially constant angle along the lantern ring upstream surface 598 to enable continuous engagement with the second pressure ring 558 and to simplify manufacture of the lantern ring 596, such as to avoid having to form multiple tapered surfaces oriented at different angles with one another.

Still referring to FIG. 5, but now in combination with FIG. 4, in contrast with the lantern ring assembly 460, which includes separate lantern rings 500, 596 having the groove 506 and the hole 520, the lantern ring assembly 560 includes a single lantern ring 596 having each of the second groove 612 configured to receive the second seal 614 to engage the reciprocating element and the hole 608 configured to direct lubricant toward the reciprocating element. Thus, the packing assembly 550 may have a fewer quantity of rings 552, 556, 556, 558, 560, which may simplify installation, maintenance, transportation, and/or storage (e.g., by reducing potential misplacement of a part of the packing assembly 550).

Regardless, each of the lantern adapter ring upstream surface 502 of the lantern adapter ring 498 and the lantern ring upstream surface 598 of the lantern ring 596 includes an arcuate surface/portion at which tapered surfaces/portions may have an increased radius (e.g., a flatter contour), such as between 0.3 cm (0.12 in) and 1 cm (0.4 in). This provides a shallower arcuate surface to avoid deep penetration into the lantern ring assembly 460, 560, which may further reduce stress concentrations. For instance, a reduced radius of the arcuate surface creates a sharper point of intersection, which may introduce potential cracking (e.g., caused by a force imparted by a rigid pressure ring compressed against the lantern ring assembly). The wider (i.e., obtuse) angle of orientation of the tapered surfaces and the arcuate surface with the increased radius distribute an imparted force to reduce stress concentrations and maintain a structural integrity of the lantern ring assembly 460, 560. Additionally, a shallower arcuate surface limits an adjacent ring, such as the second pressure rings 458, 558 from extending further into the lantern ring assembly 460, 560, which may reduce stresses imparted by the adjacent ring to the lantern ring assembly 460, 560. Furthermore, a shallower arcuate surface reduces an amount of material removed from the lantern ring assembly, thereby easing assembly and increasing a strength of the lantern ring assembly.

Further still, the wider angle of orientation of the tapered surfaces also enables the upstream surfaces 498, 598 to better accommodate an adjacent pressure ring. For example, such a profile of the upstream surfaces 498, 598 initially provides respective gaps 522, 616 between the lantern adapter ring upstream surface 502 and the second pressure ring downstream surface 494 and between the lantern adapter ring upstream surface 598 and the second pressure ring downstream surface 592. The gaps 522, 616 help accommodate positioning of the second pressure rings 458, 558. For example, compressing the second pressure ring downstream surface 494 against the lantern adapter ring upstream surface 502 causes the second pressure ring downstream surface 494 to expand radially outward. However, the gap 522 provides some space for the second pressure ring downstream surface 494 to expand before coming into contact with and correspondingly imparting a force against the lantern adapter ring upstream surface 502. In other words, the second pressure ring downstream surface 494 initially expands to close the gap 522 before further contacting and imparting a force against the lantern adapter ring upstream surface 502. Thus, the amount of force imparted by the second pressure ring 458 against the lantern adapter ring upstream surface 502 is reduced to help maintain a structural integrity of the lantern adapter ring 498. Similarly, the gap 616 allows the second pressure ring downstream surface 592 to expand a certain amount before coming into contact with and correspondingly imparting a force against the lantern ring upstream surface 598, which reduces the amount of force imparted by the second pressure ring 558 against the lantern ring upstream surface 598 to help maintain a structural integrity of the lantern ring 596.

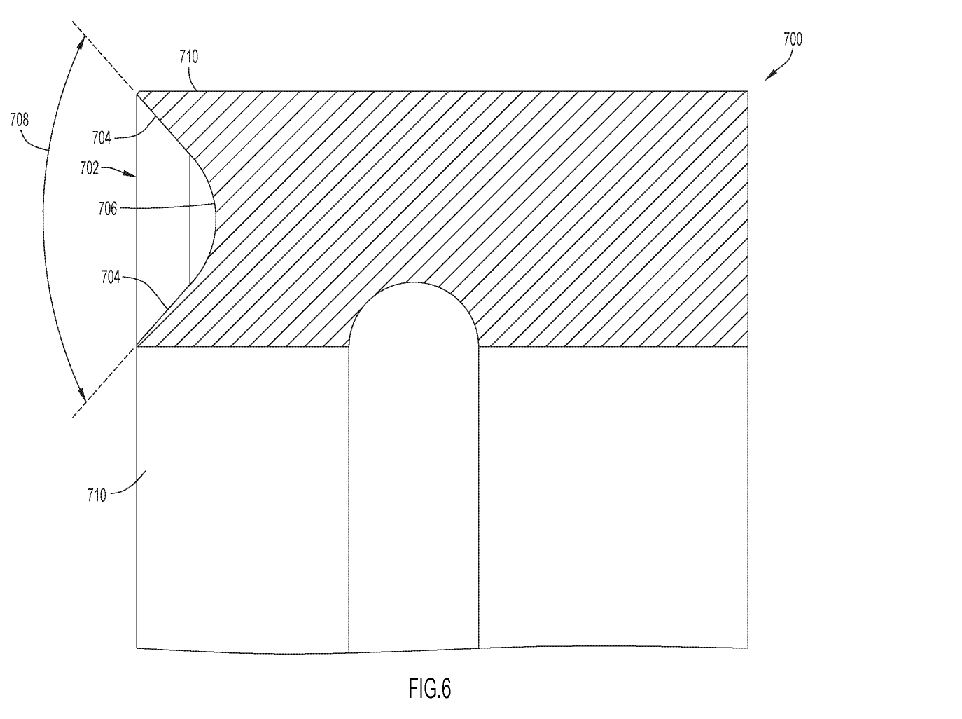

FIGS. 6-11 below illustrate various embodiments of a portion of the lantern ring assemblies 460, 560. Specifically, FIG. 6 is a side cross-sectional view of an embodiment of a lantern adapter ring 700, which may be a part of the lantern ring assembly 460 as the lantern adapter ring 498 and/or used by itself. For example, a packing nut may engage the lantern adapter ring 700 to cause the lantern adapter ring 700 to interface with an adjacent ring of a packing assembly and to retain the lantern adapter ring 700 in a fluid end. The lantern adapter ring 700 includes a lantern adapter ring upstream surface 702, which has tapered surfaces/portions 704 that intersect with an arcuate surface/portion 706. The tapered surfaces 704 are oriented at a lower obtuse angle 708, which may be between 95 degrees and 110 degrees, with one another. For example, the lower obtuse angle 708 may be approximately 95 degrees, approximately 100 degrees, approximately 105 degrees, approximately 110 degrees, etc. The tapered surfaces 704 extend linearly to the arcuate surface 706 such that the lower obtuse angle 708 at which the tapered surfaces 704 are oriented is constant along the lantern adapter ring upstream surface 702 from a side surface 710 (e.g., an inner surface configured to face the reciprocating element, an outer surface opposite the inner surface) to the arcuate surface 706. Additionally, the lower obtuse angle 708 is sufficiently high to provide the arcuate surface 706 with an increased radius to reduce stress concentrations.

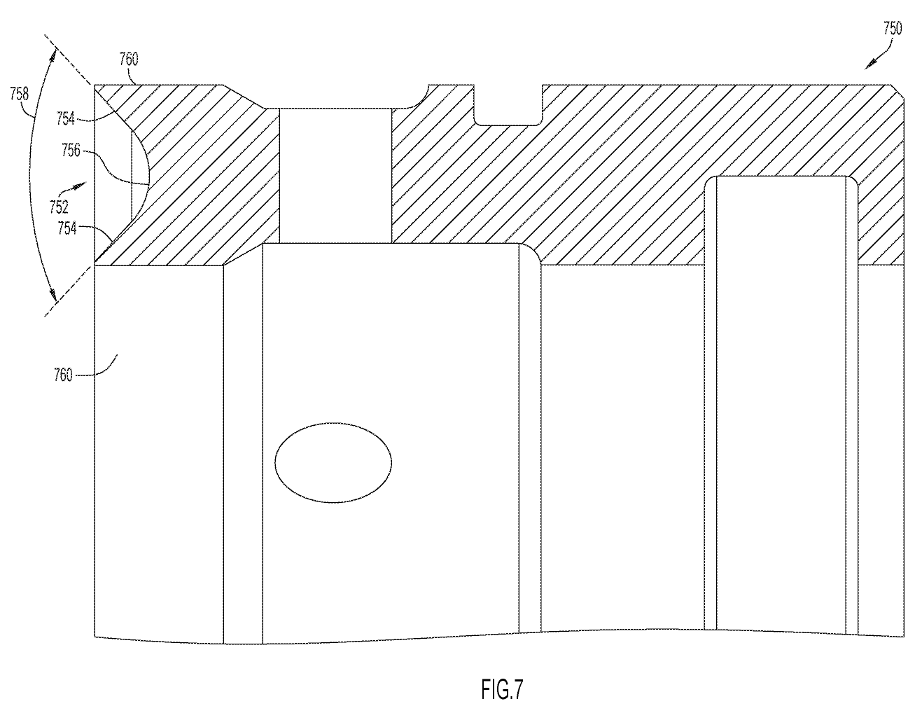

FIG. 7 is a side-cross-sectional view of an embodiment of a lantern ring 750, which may be a part of the lantern ring assembly 560 as the lantern ring 596. The lantern ring 750 includes a lantern ring upstream surface 752, which has tapered surfaces/portions 754 that intersect with an arcuate surface/portion 756. The tapered surface 754 are also oriented at a lower obtuse angle 758, which may be between 95 degrees and 110 degrees, with one another. For example, the lower obtuse angle 758 may be approximately 95 degrees, approximately 100 degrees, approximately 105 degrees, approximately 110 degrees, etc. The tapered surfaces 754 extend linearly to the arcuate surface 756 such that the lower obtuse angle 758 at which the tapered surfaces 754 are oriented is constant along the lantern ring upstream surface 752 from a side surface 760 (e.g., an inner surface configured to face the reciprocating element, an outer surface opposite the inner surface) to the arcuate surface 756. The lower obtuse angle 758 is sufficiently high to provide the arcuate surface 756 with an increased radius to reduce stress concentrations.

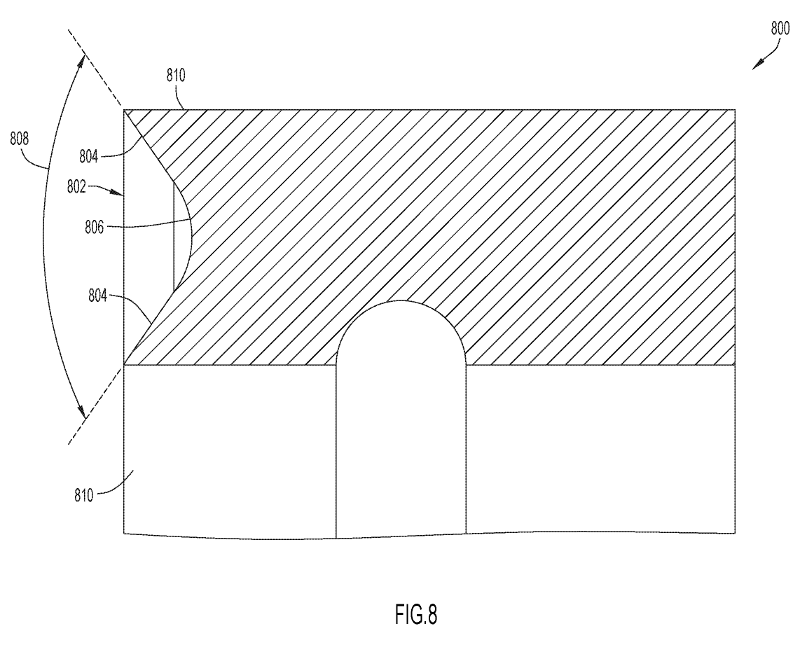

FIG. 8 is a side cross-sectional view of an embodiment of a lantern adapter ring 800, which may be a part of the lantern ring assembly 460 as the lantern adapter ring 498 and/or used by itself. For example, a packing nut may engage the lantern adapter ring 800 to cause the lantern adapter ring 800 to interface with an adjacent ring of a packing assembly and to retain the lantern adapter ring 800 in a fluid end. The lantern adapter ring 800 includes a lantern adapter ring upstream surface 802, which has tapered surfaces/portions 804 that intersect with an arcuate surface/portion 806. The tapered surfaces 804 are oriented at an intermediate obtuse angle 808, which may be between 125 degrees and 130 degrees, with one another. The tapered surfaces 804 extend linearly to the arcuate surface 806 such that the intermediate obtuse angle 808 at which the tapered surfaces 804 are oriented is constant along the lantern adapter ring upstream surface 802 from a side surface 810 (e.g., an inner surface configured to face the reciprocating element, an outer surface opposite the inner surface) to the arcuate surface 806. Thus, the arcuate surface 806 may be flatter (e.g., have a greater radius) as compared to the arcuate surface 706 of the lantern adapter ring 700 to further reduce stress concentrations.

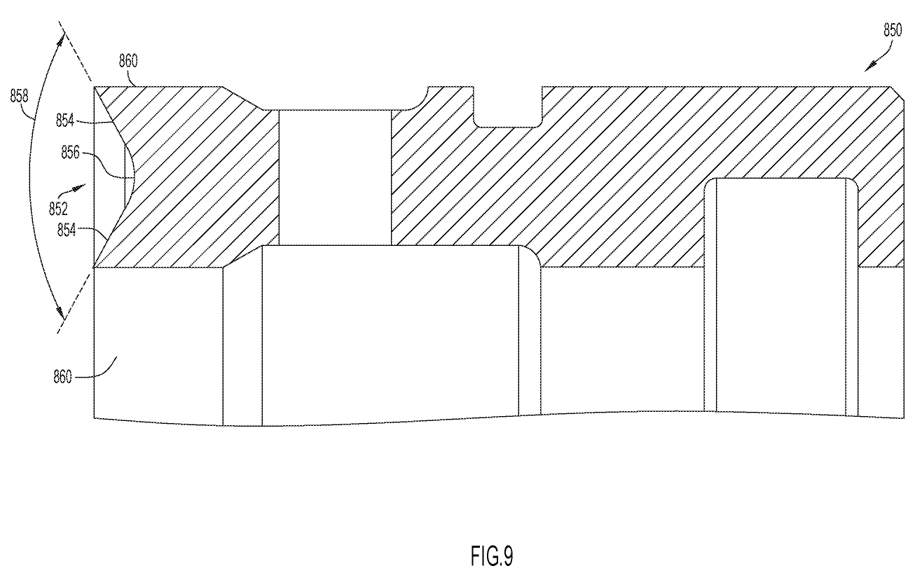

FIG. 9 is a side-cross-sectional view of an embodiment of a lantern ring 850, which may be a part of the lantern ring assembly 560 as the lantern ring 596. The lantern ring 850 includes a lantern ring upstream surface 852, which has tapered surfaces/portions 854 that intersect with an arcuate surface/portion 856. The tapered surface 854 are also oriented at an intermediate obtuse angle 858, which may be between 125 degrees and 130 degrees, with one another, and the tapered surfaces 854 extend linearly to the arcuate surface 856 such that the intermediate obtuse angle 858 at which the tapered surfaces 854 are oriented is constant along the lantern adapter ring upstream surface 852 from an outer surface 860 (e.g., an inner surface configured to face the reciprocating element, an outer surface opposite the inner surface) to the arcuate surface 856. As is discussed in further detail, however, tapered surfaces need not be linear and at least some embodiments of the present application may include arcuate tapering. Thus, the arcuate surface 856 may be flatter (e.g., have a greater radius) as compared to the arcuate surface 756 of the lantern ring 750 to further reduce stress concentrations.

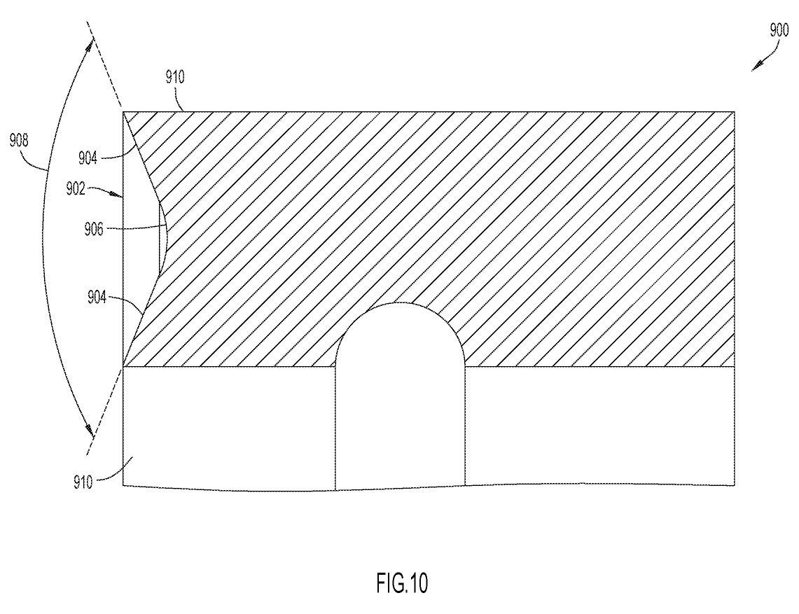

FIG. 10 is a side cross-sectional view of an embodiment of a lantern adapter ring 900, which may be a part of the lantern ring assembly 460 as the lantern adapter ring 498. The lantern adapter ring 900 includes a lantern adapter ring upstream surface 902, which has tapered surfaces/portions 904 that intersect with an arcuate surface/portion 906. The tapered surfaces 904 are oriented at a greater obtuse angle 908, which may be between 150 degrees and 160 degrees, with one another. The tapered surfaces 904 extend linearly to the arcuate surface 906 such that the greater obtuse angle 908 at which the tapered surfaces 904 are oriented is constant along the lantern adapter ring upstream surface 902 from an outer surface 910 (e.g., an inner surface configured to face the reciprocating element, an outer surface opposite the inner surface) to the arcuate surface 906. Thus, the arcuate surface 906 may be even flatter (e.g., have an even greater radius) as compared to the arcuate surfaces 706, 806 to reduce stress concentrations.

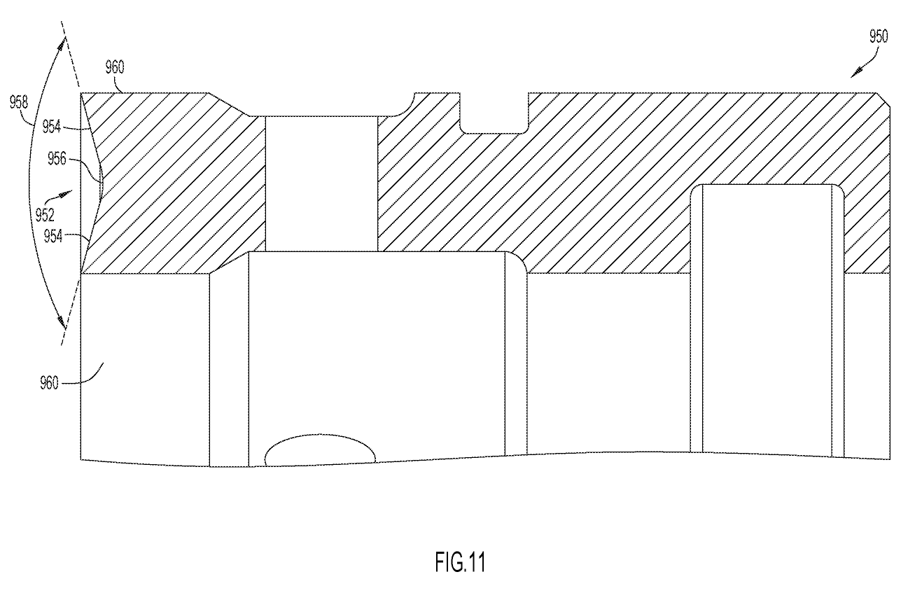

FIG. 11 is a side-cross-sectional view of an embodiment of a lantern ring 950, which may be a part of the lantern ring assembly 560 as the lantern ring 596. The lantern ring 950 includes a lantern ring upstream surface 952, which has tapered surfaces/portions 954 that intersect with an arcuate surface/portion 956. The tapered surface 954 are also oriented at a greater obtuse angle 958, which may be between 150 degrees and 160 degrees, with one another, and the tapered surfaces 954 extend linearly to the arcuate surface 956 such that the greater obtuse angle 958 at which the tapered surfaces 954 are oriented is constant along the lantern adapter ring upstream surface 952 from an outer surface 960 (e.g., an inner surface configured to face the reciprocating element, an outer surface opposite the inner surface) to the arcuate surface 956. Thus, the arcuate surface 956 may be even flatter (e.g., have an even greater radius) as compared to the arcuate surfaces 756, 856 to reduce stress concentrations.

Increasing the obtuse angles at which tapered surfaces/portions of a lantern ring assembly are oriented and/or increasing a radius of an arcuate surface/portion of a lantern ring assembly reduces a stress concentration during operation of a reciprocating pump. For example, the reduced stress concentration will reduce fatigue and potential for cracking of material (e.g., a metal alloy, such as an aluminum-bronze alloy), thereby reducing potential for unexpected, premature packing/sealing failure that otherwise may damage the fluid end or other components of the reciprocating pump. Accordingly, the lantern ring assemblies discussed herein are able to sustain mechanical loads from higher-pressure pumping conditions (e.g., greater than 11,500 pounds per square inch) to increase functionality and reliability of a packing assembly for sealing. In certain embodiments, a lantern ring assembly may be reused with new packing components, such as a new pressure ring configured to engage an upstream surface (e.g., the tapered surfaces, the arcuate surface) of the lantern ring assembly, without introducing changes in structural integrity or mechanical failure of the lantern ring assembly.

Across the embodiments of the present application, however, the tapered surfaces may be oriented at a constant obtuse angle. That is, the tapered surfaces of the upstream surface on the lantern ring assembly – whether formed in a lantern adapter ring (e.g., any of the lantern adapter rings 498, 700, 800, 900), a lantern lubricant ring, or a single-piece lantern ring (e.g., any of the lantern rings 596, 750, 850, 950) – may be oriented at a single, continuous angle up to the arcuate surface. This may ensure the lantern ring assembly fully engages an adjacent ring, e.g., a pressure ring, to fully distribute forces and/or stress across the upstream surface. The single, continuous angle may also make the upstream surface easier to manufacture than, for example, an upstream surface with compound angle surfaces (i.e., tapered surfaces oriented at different angles leading up to an arcuate surface). Similarly, across the embodiments of the present application, the arcuate surface may be shallower (e.g., formed with a relatively large radius), to minimize the depth of the upstream surface. This limits the amount of material that needs to be removed from the lantern ring assembly to form the upstream surface, which further eases manufacturing and improves stress conditions. The flatter arcuate surface also prevents or at least discourages an adjacent ring from penetrating too far into the lantern ring assembly, which can reduce stresses imparted by the adjacent ring to the upstream surface of the lantern ring assembly, further preventing or at least discouraging damage, such as cracking. This is particularly important when the ring adjacent the lantern ring assembly is relatively strong or stiff, such as a pressure ring formed from or reinforced with fabric or aramid materials/fibers, such as KEVLAR.

It should be noted that as used herein, a “tapered” surface can include a linearly (e.g., planarly) extending surface and/or an arcuately extending surface extending toward a centrally extending arcuate surface. Meanwhile, the ends of the arcuate surface that extend away from one another and therefore may connect at least a pair of opposite extending tapered surfaces. As an example, any of the upstream surfaces 502, 598, 702, 752, 802, 852, 902, 952 may have multiple arcuate surfaces (e.g., having a compound radii arrangement) connected to one another. As another example, any of the upstream surfaces 502, 598, 702, 752, 802, 852, 902, 952 may have a single arcuate surface (i.e., no tapered surface). However, linearly extending surfaces may provide the upstream surface with a greater amount of surface area to capture an adjacent ring for coupling while still having a relatively smooth transition (e.g., less discontinuities) to reduce stress concentrations and avoid localized contact with the adjacent ring that could increase stress imparted on the tapered surface. For example, surfaces that extend linearly and tangentially to an arcuate surface may avoid inwardly extending points or corners that otherwise could concentrate stress and/or become contact points with an adjacent ring. Thus, a profile of an upstream surface having a linearly extending surface may better distribute stress (e.g., imparted during operation of a reciprocating pump), accommodate an adjacent ring (e.g., avoid localized stress points as the adjacent ring expands against the tapered surface during compression against the lantern ring), or otherwise avoid creating stress concentrations to preserve a structural integrity of the tapered surface.

While the disclosure has been illustrated and described in detail and with reference to specific embodiments thereof, it is nevertheless not intended to be limited to the details shown, since it will be apparent that various modifications and structural changes may be made therein without departing from the scope and within the scope and range of equivalents of the claims. In addition, various features from one of the embodiments may be incorporated into another of the embodiments. As an example, a lantern ring assembly may include separate lantern rings to form a similar profile as that shown in the lantern ring assemblies 560, 750, 850. That is, such a lantern ring assembly may include a first lantern having a hole (e.g., similar to the hole 608) for directing lubricant to a reciprocating pump, as well as a second lantern ring having a groove (e.g., similar to the second groove 612) configured to receive a seal (e.g., an O-ring, a lip seal) for compressing against the reciprocating element. As another example, a lantern ring assembly may include a single lantern ring having a combination of features of the lantern ring assembly 460 with multiple lantern rings 498, 500 and of the lantern ring assembly 560 with a single lantern ring 596. For instance, the single lantern ring may have a groove (e.g., similar to the groove 506) facing the reciprocating element and configured to carry lubrication and/or help collect debris, as well as at least one of a hole (e.g., similar to the hole 608) for directing lubricant to a reciprocating pump or a groove (e.g., similar to the second groove 612) configured to receive a seal (e.g., an O-ring, a lip seal) for compressing against the reciprocating element). In any case, the lantern ring assembly includes a lantern adapter ring upstream surface with tapered surfaces extending toward one another in a manner (e.g., by forming an obtuse angle) to reduce stress concentrations. Accordingly, it is appropriate that the appended claims be construed broadly and in a manner consistent with the scope of the disclosure as set forth in the following claims.

Similarly, it is intended that the present disclosure covers the modifications and variations of this disclosure that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

What is claimed is:

1. A lantern ring assembly of a packing assembly for a reciprocating pump, the lantern ring assembly comprising:
a hole configured to receive lubricant and direct lubricant toward a reciprocating element of the reciprocating pump; and
a surface configured to receive a portion of an adjacent ring of the packing assembly, wherein the surface comprises tapered surfaces extending toward one another, and the tapered surfaces are oriented at an obtuse angle relative to one another.

2. The lantern ring assembly of claim 1, wherein the surface comprises an arcuate surface, and the tapered surfaces extend to intersect with the arcuate surface.

3. The lantern ring assembly of claim 2, wherein the obtuse angle at which the tapered surfaces are oriented is constant along the surface to the arcuate surface.

4. The lantern ring assembly of claim 1, comprising a single lantern ring with the hole and the surface.

5. The lantern ring assembly of claim 4, wherein the single lantern ring comprises a groove facing the reciprocating element.

6. The lantern ring assembly of claim 1, comprising:
a first ring comprising the hole; and
a second ring comprising the surface, wherein the second ring is configured to engage the first ring.

7. The lantern ring assembly of claim 6, wherein the second ring comprises a groove facing the reciprocating element.

8. The lantern ring assembly of claim 6, wherein the second ring comprises an additional surface, opposite the surface, configured to engage the first ring, the first ring comprises a recess formed around the first ring, the hole extends to the recess, and the additional surface of the second ring is exposed to the recess.

9. A lantern adapter ring of a packing assembly for a reciprocating pump, the lantern adapter ring comprising:
a first surface configured to engage a lantern lubricant ring of the packing assembly; and
a second surface, opposite the first surface, configured to engage an adjacent ring of the packing assembly, wherein the second surface comprises tapered portions extending toward one another, and the tapered portions are oriented at an obtuse angle relative to one another.

10. The lantern adapter ring of claim 9, wherein the second surface comprises an arcuate portion, and the tapered portions extend to the arcuate portion.

11. The lantern adapter ring of claim 10, wherein the obtuse angle at which the tapered portions are oriented is constant along the second surface to the arcuate portion.

12. The lantern adapter ring of claim 9, wherein the second surface is planar.

13. The lantern adapter ring of claim 9, comprising a groove facing a reciprocating element of the reciprocating pump.

14. The lantern adapter ring of claim 9, wherein the second surface forms a portion of a recess of the lantern lubricant ring upon engaging the second surface with the lantern lubricant ring, and the recess of the lantern lubricant ring is configured to direct lubricant around the lantern lubricant ring.

15. A packing assembly for a reciprocating pump, the packing assembly comprising:
a pressure ring configured to seal against a reciprocating element of the reciprocating pump; and
a lantern ring configured to receive a portion of the pressure ring, wherein the lantern ring comprises an upstream surface configured to engage the portion of the pressure ring, and the upstream surface comprises tapered surfaces oriented with one another at greater than 90 degrees.

16. The packing assembly of claim 15, comprising an additional lantern ring configured to engage the lantern ring, wherein the additional lantern ring comprises a hole configured to direct lubricant toward the reciprocating element.

17. The packing assembly of claim 15, wherein the lantern ring comprises a hole configured to direct lubricant toward the reciprocating element.

18. The packing assembly of claim 15, wherein the upstream surface of the lantern ring comprises an arcuate surface, and the tapered surfaces extend toward one another to the arcuate surface.

19. The packing assembly of claim 15, wherein the lantern ring comprises a groove facing the reciprocating element.

20. The packing assembly of claim 15, comprising:
an additional pressure ring configured to engage the pressure ring and seal against the reciprocating element;
a header ring configured to engage the pressure ring and scrape against the reciprocating element; and
a junk ring configured to engage the header ring and a fluid end of the reciprocating pump.
